(19) United States
(12) Patent Application Publication
(10) Pub. No.: US 2024/0176647 A1
(43) Pub. Date: May 30, 2024

(54) BLOCKCHAIN REQUEST PRESCREENING FOR PARALLEL REQUEST PROCESSING

(71) Applicant: VMware, Inc., Palo Alto, CA (US)

(72) Inventors: Ram Krishnan, Cupertino, CA (US); Kostas Teofanidis, Sofia (BG); Dharmaraj Rajendra Parmar, Cupertino, CA (US); Nischal Sharma, Bangalore (IN); Nisha Shekhawat, Bangalore (IN); Vijaya Prakash Masilamani, Bangalore (IN)

(21) Appl. No.: 18/071,904

(22) Filed: Nov. 30, 2022

(51) Int. Cl. G06F 9/48

(52) U.S. Cl. CPC G06F 9/48

(57) ABSTRACT

This disclosure describes aspects of parallel processing of blockchain requests, including prescreening that prevents conflicts for parallel processing. In some examples, an address is identified from a blockchain request. The blockchain request is prescreened to determine a conflict status. The conflict status is determined by comparing the address from the blockchain request to at least one address in a parallel execution batch. The blockchain request is placed in the parallel execution batch or a subsequent parallel execution batch based on the conflict status. The blockchain request is performed by parallel processing of the parallel execution batch or the subsequent parallel execution batch.

### BACKGROUND

Blockchains are becoming a popular solution for enterprises to support fungible and non-fungible transactions. Blockchain transactions can enable users to access a durable history of transactions as well as the current status of transactional information. This provides additional security and trackability for transactions, providing additional security through transparency. Contracts, payments, agreements, asset records, chains of custody, ownership information, property rights, data logs, and other transactional information can be represented. Blockchains can be used as a transparent and durable way to record activity in a manner that maintains data so that it is not easily altered, corrupted, or destroyed.

However, certain aspects of blockchain techniques and infrastructures can be inefficient and ineffective. For example, blockchain systems can generally process incoming requests sequentially, causing delays and inefficiencies in processing and updating. As a result, there is a need for more efficient and effective blockchain infrastructures.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting a networked environment that includes components of a blockchain architecture that enables blockchain request prescreening for parallel request processing, according to embodiments of the present disclosure.

FIG. 2 is a drawing depicting an example of decentralized access management functionalities performed by the blockchain architecture of FIG. 1, according to embodiments of the present disclosure.

FIG. 3 is a flowchart depicting functionalities performed by the blockchain architecture of FIG. 1, according to embodiments of the present disclosure.

FIG. 4 is a drawing depicting a computing device for one or more of the components of the blockchain architecture.

### DETAILED DESCRIPTION

The present disclosure describes a blockchain architecture that enables blockchain request prescreening for parallel request processing. The present disclosure improves aspects of blockchain infrastructures that can be ineffective. Existing blockchain solutions can provide privacy and blockchain integrity but the existing solutions are not resource efficient and performant. For example, existing blockchain systems can process incoming requests sequentially, causing delays and inefficiencies in processing and updating. Even if blockchain systems were to use parallel processing, the systems would become prone to error if multiple transactions were to be applied to the same blockchain or same user account. However, the present disclosure describes mechanisms that enable faster processing while maintaining integrity by preventing blockchain conflict issues.

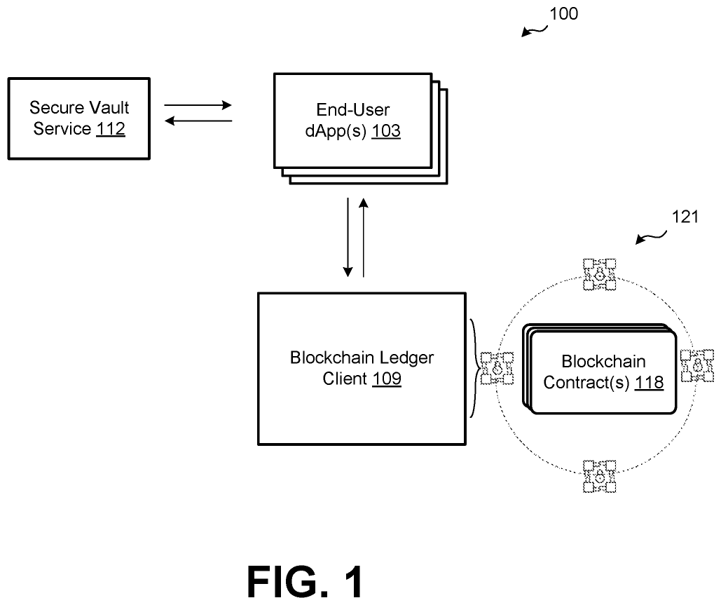

Moving to the figures, FIG. 1 shows a secure blockchain architecture 100 with decentralized access management as well as other security features. The blockchain architecture 100 can include an end-user decentralized application (dApp) 103, a blockchain ledger client 109, a secure vault service 112, and a blockchain contract 118, which are in communication with one another, for example, over one or more networks.

The networks can include wide area networks (WANs), local area networks (LANs), and other networks. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The networks can also include a combination of two or more networks. Examples of networks can include the Internet, intranets, extranets, virtual private networks (VPNs), and similar networks.

The dApp 103 can include an application built on a decentralized network that includes a frontend user interface that facilitates interactions with a blockchain contract such as the blockchain contract 118. The dApp 103 can be executed using code running on a decentralized peer-to-peer network.

The dApp 103, which has access to an internal or external wallet, can sign all requests including reads, filter configurations, as well as writes. Support for the signature requirement for non-write requests and transactions such as reads, and filter configurations can be enabled using modified integration libraries such as web3j libraries that support signing of all types of blockchain requests. Alternatively, the contract implementation services 106 can be permissioned to use an external wallet or secure vault service 112 that manages private keys.

The blockchain ledger client 109 can be part of a decentralized network of blockchain nodes that executes a blockchain such as the blockchain contract 118. The blockchain ledger client 109 can provide an interface for administrators, developers, and users to interact with the decentralized network of blockchain nodes. The decentralized network of nodes can include one or more blockchain ledger client 109 node, as well as a number of replication nodes 121.

The blockchain ledger client 109 can include one or more nodes of the network that provide a data transmission based interface for interactions with the blockchain contract 118. The blockchain ledger client 109 can provide one or more Application Programming Interfaces (APIs) that can be invoked in order to interact with the blockchain contract 118. The API or APIs can be invoked to read and write to the blockchain contract 118. This can enable any kind of contract transaction such as a transfer of tangible or intangible property from one party to another; adding, removing, and modifying contract terms; adding and removing administrative or privileged users; enabling, disabling, and modification of decentralized authentication and authorization rules for particular end-user dApps 103 for particular users, and other transactions.

The secure vault service 112 can include a service capable of safely providing dynamic secrets delivery, including management of private keys for interactions with a blockchain such as the blockchain contract 118. The secure vault service 112 can be a third-party service that is employed by the various components of the contract implementation services 106.

The replication nodes 121 can be blockchain nodes that store and maintain the blockchain contract 118. A consensus algorithm can allow the decentralized network of blockchain nodes reach a common agreement or consensus about the present state of the distributed blockchain contract 118. The replication nodes 121 and other blockchain nodes can include mechanisms that can perform a conflict prescreening for a batch of blockchain requests.

This conflict prescreening can prevent conflicts for parallel processing of the batch of blockchain requests. Without the conflict prescreening, two different transactions performed against the same blockchain contract 118 can retrieve the same data from the blockchain contract 118, when one of the two should use a result from the other transaction. The sequence of transactions could be incorrect, causing an error. Even if the two transactions could be performed in either order, the result of one of the transactions should be the starting point of the other. Since this causes at least one of the transactions to have an errant starting point, the blocks written based on unscreened parallel blockchain transaction requests can be errant. If both transactions for a blockchain contract 118 are from the same end-user dApp 103, then the chances for a conflict error can be vastly increased, depending on the type of blockchain contract 118. However, there can still be errors if different end-users interact with the same blockchain contract 118.

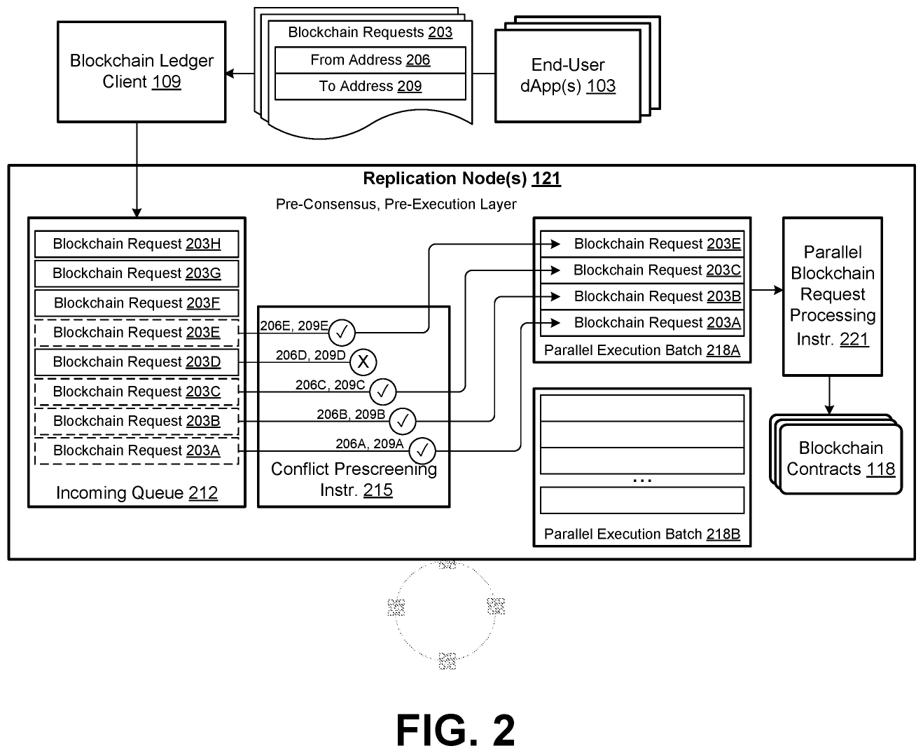

FIG. 2 shows an example of blockchain request prescreening and parallel request processing functionalities performed by the blockchain architecture 100. In this example, the blockchain architecture 100 can include the end-user decentralized application (dApp) 103, the blockchain ledger client 109, the blockchain contract 118, and the replication nodes 121.

Various end-user dApps 103 can transmit blockchain requests 203 to the blockchain ledger client 109. There can be multiple such blockchain requests 203 transmitted by multiple different end-user dApps 103. The blockchain ledger client 109 can expose one or more APIs that enable users to interact with various blockchain contracts 118. The end-user dApps 103 can invoke an API in order to transmit blockchain requests 203 that specify actions such as write transactions and read calls for various blockchain contracts 118.

A blockchain request 203 can specify an action to perform, as well as an addresser or a “from” address 206 and an addressee or a “to” address 209. The from address 206 can be an account identifier or account network address associated with the user or the end-user dApp 103 that originates the blockchain request 203. The to address 209 can be a blockchain network address or identifier associated with a blockchain contract 118.

The blockchain ledger client 109 can provide the blockchain requests 203 to the replication nodes 121 to perform a specified action. The replication nodes 121 can place the blockchain requests 203 into an arrival queue or incoming queue 212. The incoming queue 212 can generally be processed in a first-in-first-out (FIFO) manner. However, as described herein, the replication nodes 121 can reorder processing of the blockchain requests 203 in the incoming queue 212 as a result of a prescreening process.

In one nonlimiting example, the incoming queue 212 can include a number of enqueued blockchain requests 203A through 203H. The blockchain request 203A can be an earliest request received from the blockchain ledger client 109 that still remains enqueued in the incoming queue 212; blockchain request 203B can be a second earliest request received from the blockchain ledger client 109; blockchain request 203C can be a third earliest request received from the blockchain ledger client 109, and so on. The blockchain request 203H can be a latest request received from the blockchain ledger client 109.

The conflict prescreening instructions 215 can perform a preliminary conflicts check that can prevent errors. As described above, two transactions for the same blockchain contract 118 can have a chance to cause an error if they affect the same value that is tracked or stored in the blockchain contract 118, such as the same account value, or the same object tracked using the blockchain contract 118. Further, if the same end-user dApp 103 performs two different blockchain requests 203, then the chances for a conflict error can be increased. The conflict prescreening instructions 215 can reduce, minimize, or prevent these errors.

The conflict prescreening instructions 215 can use the respective from addresses 206 and to addresses 209 to prevent the parallel execution batch 218A from including two blockchain requests 203 that have the same addresses. The conflict prescreening instructions 215 can compare a from address 206 to a list of all from addresses 206 in the parallel execution batch 218A; in some examples, the conflict prescreening instructions 215 can also compare the from address 206 to a list of all to addresses 209 in the parallel execution batch 218A. The conflict prescreening instructions 215 can also compare a to address 209 to a list of all to addresses 209 in the parallel execution batch 218A; in some examples, the conflict prescreening instructions 215 can also compare the to address 209 to a list of all from addresses 206 in the parallel execution batch 218A.

For example, the conflict prescreening instructions 215 can identify the blockchain request 203A as the next request to prescreen. The conflict prescreening instructions 215 can identify the from address 206A and the to address 209A of the blockchain request 203A. Since the parallel execution batch 218A is empty prior to placing the blockchain request 203A, there are no addresses in the parallel execution batch 218A to create a conflict. The conflict prescreening instructions 215 can take the blockchain request 203A from the incoming queue 212 and place it in the parallel execution batch 218A.

The conflict prescreening instructions 215 can then identify the blockchain request 203B as the next request to prescreen. The conflict prescreening instructions 215 can identify the from address 206B and the to address 209B of the blockchain request 203B, and compare these addresses to the from address 206A and the to address 209A of the blockchain request 203A that is already in the parallel execution batch 218A. In this example, the conflict prescreening instructions 215 can identify that the from address 206B and the to address 209B of the blockchain request 203B has no conflicts with any of the addresses listed in requests previously placed in the parallel execution batch 218A. In other words, the conflict prescreening instructions 215 can identify a “negative” conflict status indicating that the blockchain request 203B is not in conflict with addresses of other requests already in the parallel execution batch 218A. The conflict prescreening instructions 215 can take the blockchain request 203B from the incoming queue 212 and place it in the parallel execution batch 218A along with the blockchain request 203A.

The conflict prescreening instructions 215 can then identify the blockchain request 203C as the next request to prescreen. The conflict prescreening instructions 215 can identify the from address 206C and the to address 209C of the blockchain request 203C, and compare these addresses to those of the blockchain requests 203A and 203B that are already in the parallel execution batch 218A. In this example, the conflict prescreening instructions 215 can identify that the from address 206C and the to address 209C of the blockchain request 203C has no conflicts with any of the addresses listed in requests previously placed in the parallel execution batch 218A. In other words, the conflict prescreening instructions 215 can identify a “negative” conflict status indicating that the blockchain request 203C is not in conflict with addresses of other requests already in the parallel execution batch 218A. The conflict prescreening instructions 215 can take the blockchain request 203C from the incoming queue 212 and place it in the parallel execution batch 218A along with the blockchain request 203A and the blockchain request 203B.

The conflict prescreening instructions 215 can then identify the blockchain request 203D as the next request to prescreen. The conflict prescreening instructions 215 can identify the from address 206D and the to address 209D of the blockchain request 203D, and compare them to the addresses of the blockchain requests 203A-203C that are already in the parallel execution batch 218A. In this example, the conflict prescreening instructions 215 can identify that the from address 206D matches one of the addresses from the blockchain requests 203A-203C, and that the to address 209D matches one of the addresses from the blockchain requests 203A-203C. The conflict prescreening instructions 215 can determine that the blockchain request 203D conflicts with the parallel execution batch 218A based on one or more of the matches that are identified. In other words, the conflict prescreening instructions 215 can identify a “positive” conflict status indicating that the blockchain request 203B is in conflict with one or more addresses of other requests already in the parallel execution batch 218A. As a result, the conflict prescreening instructions 215 can prevent or decline to place the blockchain request 203D in the parallel execution batch 218A for parallel execution.

In various embodiments, the conflict prescreening instructions 215 can leave or replace the blockchain request 203D back in the incoming queue 212 and proceed with consideration of the next requests; or place the blockchain request 203D in the next parallel execution batch 218B. In some examples, the parallel execution batches 218A and 218B can be stored as a batch queue that can include any number of parallel execution batches 218. The batch queue can be performed in sequential order to prevent multiple parallel execution batches 218 from being processed. A single parallel execution batch 218 can have any predetermined number of blockchain requests 203, and all of the blockchain requests 203 in a single parallel execution batch 218 can be performed in parallel. Performing the blockchain requests 203 in parallel can include performing the requests starting substantially at the same time and with at least partial concurrence. Some blockchain requests 203 can complete at different times relative to the other blockchain requests 203.

In various examples, the conflict prescreening instructions 215 can place the conflicting blockchain request 203D at the front of the queue (i.e., next to process), or can place the conflicting blockchain request 203D at the back of the queue. If the conflict prescreening instructions 215 places the conflicting blockchain request 203D at the front of the queue, the conflict prescreening instructions 215 can decline reconsideration of the blockchain request 203D until the parallel execution batch 218A is full. Alternatively, the conflict prescreening instructions 215 can temporarily store the blockchain request 203D until the parallel execution batch 218A is full, and then place it at the front of the queue or in the next parallel execution batch 218B. In any case, the conflict prescreening instructions 215 can prevent the conflicting blockchain request 203D from being placed in a current parallel execution batch 218A, and ultimately place it in a subsequent parallel execution batch 218B, whether it is placed there immediately or after being re-enqueued or temporarily stored.

The conflict prescreening instructions 215 can then identify the blockchain request 203E as the next request to prescreen. The conflict prescreening instructions 215 can determine that there are no conflicts with the blockchain requests 203A-203C in the parallel execution batch 218A, and can place the blockchain request 203E in the parallel execution batch 218A.

The parallel blockchain request processing instructions 221 can process the blockchain requests 203A-203C and 203E in parallel using the blockchain contracts 118. This can include reading the respective blockchain contracts 118, and in some cases can further include writing blocks to the respective blockchain contracts 118 to document the action. This can include writing a block to document a transaction. Some blockchain contracts 118 can also enforce writing a block to document a read action.

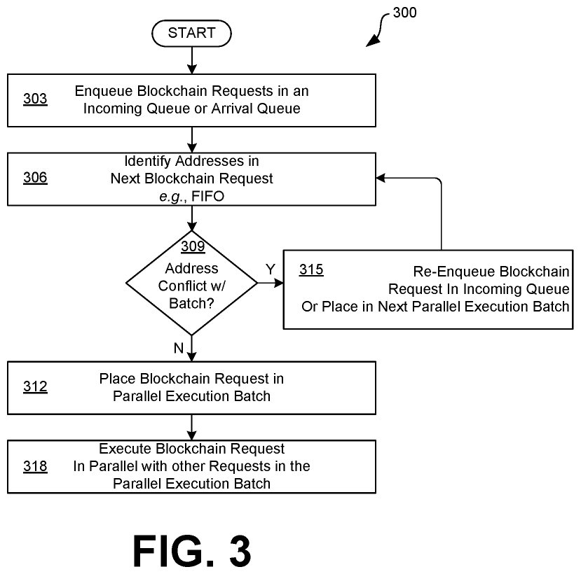

FIG. 3 shows a flowchart 300 that provides an example of blockchain request prescreening and parallel request processing functionalities performed by the blockchain architecture 100. Generally, the flowchart 300 shows how the replication nodes 121 can perform conflict prescreening and parallel blockchain request processing. While a particular step of the flowchart 300 can be described as being implemented by a particular component of the blockchain architecture 100, other components can perform certain aspects of the various steps.

In step 303, the replication node or nodes 121 can enqueue a number of blockchain requests 203 in an incoming queue 212. The blockchain ledger client 109 can provide the blockchain requests 203 to the replication nodes 121 to perform a specified action. The replication nodes 121 can receive the blockchain requests 203 from the blockchain ledger client 109. The replication nodes 121 can enqueue each of the blockchain requests 203 in an incoming queue 212 in the order that they are received.

In step 306, the replication nodes 121 can identify addresses in a next blockchain request 203. Generally, the replication nodes 121 can prescreen the blockchain requests 203 in the incoming queue 212 in the order that they are received. The selected blockchain request 203 to consider can be an oldest or longest-resident blockchain request 203. The replication nodes 121 can extract and read a from address 206 and a to address 209 from the blockchain request 203 that is being prescreened. These addresses can be used to identify whether a conflict exists with a parallel execution batch 218.

In step 309, the replication nodes 121 can determine whether there is an address conflict with a parallel execution batch 218. Each blockchain request 203 in the parallel execution batch 218 can specify a corresponding from address 206, and a corresponding to address 209. The replication nodes 121 can compare the from address 206 and the to address 209 of the blockchain request 203 that is being prescreened to those of the parallel execution batch 218. The from address 206 of the blockchain request 203 that is being prescreened can be compared to all of the from addresses 206 in the parallel execution batch 218. The from address 206 of the blockchain request 203 that is being prescreened can also be compared to all of the to addresses 209 in the parallel execution batch 218. Likewise, the to address 209 of the blockchain request 203 that is being prescreened can be compared to all of the to addresses 209 in the parallel execution batch 218. The to address 209 of the blockchain request 203 that is being prescreened can also be compared to all of the from addresses 209 in the parallel execution batch 218. Any one or more of these operations can be performed.

A conflict can be identified if the from address 206 and/or the to address 209 of the blockchain request 203 that is being prescreened matches an address listed in any of the blockchain requests 203 already in the parallel execution batch 218. If there is no conflict, conflict, then the process can move to step 312. Otherwise, if there is a conflict, then the process can move to step 315.

In step 312, the replication nodes 121 can place the blockchain request 203 in the parallel execution batch 218. The parallel execution batch 218 can be a staging area for a parallel execution process for the set of blockchain requests 203 in the batch. The parallel execution batch 218 can be associated with predetermined parallel execution rules or requirements, such as a predetermined threshold or maximum number of blockchain requests 203 that indicate the parallel execution batch 218 is full. The rules can also indicate that if there are no non-conflicting blockchain requests 203 are in the incoming queue 212 for a threshold period of time, then the parallel processing should proceed even if the threshold number of blockchain requests 203 is unmet.

In step 315, the replication nodes 121 can re-enqueue the blockchain request 203 or place the blockchain request 203 in a subsequent parallel execution batch 218. For example, if the blockchain architecture 100 maintains multiple parallel execution batches 218 to be performed sequentially, then the replication nodes 121 can place the blockchain request 203 in a subsequent parallel execution batch 218 that is to be processed after the parallel execution batch 218. Otherwise, the replication nodes 121 can re-enqueue the blockchain request 203 in the incoming queue 212. In some examples, the replication nodes 121 can temporarily store or hold the blockchain request 203 until the current parallel execution batch 218 is full or has stated parallel processing, and then place the blockchain request 203 in the subsequent parallel execution batch 218 or the incoming queue 212.

In step 318, the replication nodes 121 can execute the blockchain request 203 in parallel with other requests in the current parallel execution batch 218. For example, the replication nodes 121 can identify that the current parallel execution batch 218 is full, or contains a predetermined number of blockchain requests 203, or no further blockchain requests 203 are in the incoming queue 212 for a threshold period of time. Any of these scenarios can trigger the replication nodes 121 to perform parallel processing of the blockchain requests 203 that are in the current parallel execution batch 218.

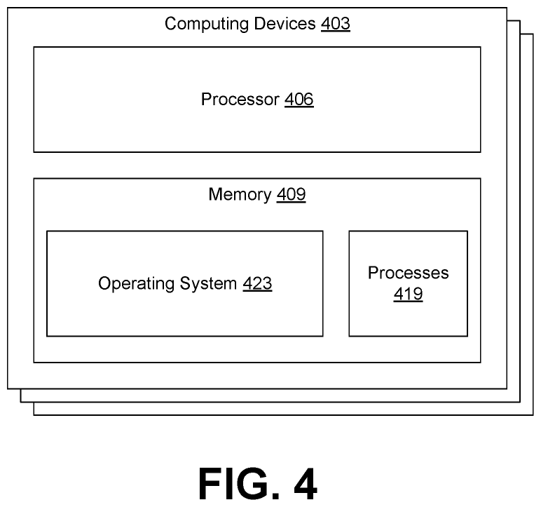

FIG. 4 depicts a schematic block diagram of one example of one or more computing devices 403 for the components of the networked environment of FIG. 1, according to various embodiments of the present disclosure. A computing device 403 can have one or more processors 406. The computing device 403 can also have a memory 409.

The processor 406 can represent any circuit or combination of circuits that can execute one or more machine-readable instructions stored in the memory 409 that make up a computer program or process and store the results of the execution of the machine-readable instructions in the memory 409. In some implementations, the processor 406 may be configured to perform one or more machine-readable instructions in parallel or out of order. This could be done if the processor 406 includes multiple processor cores and/or additional circuitry that supports simultaneous multithreading (SMT). Examples of a processor 406 can include a central processing unit (CPU), a graphics processing unit (GPU), a field-programmable gate array (FPGA), application specific integrated circuits (ASICs), etc.

The memory 409 can include both volatile and nonvolatile memory and data storage components. Volatile components are those that do not retain data values upon loss of power. Nonvolatile components are those that retain data upon a loss of power. Thus, the memory 409 can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device. Various types of data and machine-readable instructions may be stored in the memory 409. For example, one or more processes 419 may be stored in the memory 409. In some implementations, an operating system 423 may also be stored in the memory 409.

A process 419 can represent a collection of machine-readable instructions stored in the memory 409 that, when executed by the processor 406 of the computing device 403, cause the computing device 403 to perform one or more tasks. A process 419 can represent a program, a sub-routine or sub-component of a program, a library used by one or more programs, etc. When a process requests access to a hardware or software resource for which it lacks permission to interact with, the process 419 can generate an interrupt and provide or send the interrupt to the operating system 423.

The operating system 423 can include any system software that manages the operation of computer hardware and software resources of the computing device 403. The operating system 423 can also provide various services or functions to computer programs, such as processes 419, that are executed by the computing device 403. Accordingly, the operating system 423 may schedule the operation of tasks or processes 419 by the processor 406, act as an intermediary between processes 419 and hardware of the computing device 403. The operating system 423 may also implement and/or enforce various security safeguards and mechanisms to prevent access to hardware or software resources by unprivileged or unauthorized users or processes 419.

The operating system 423 can also implement a virtual memory system that provides an abstract representation of the memory 409 available on the computing device 403, such as the RAM. Among the features provided by the virtual memory system are a per process 419 address space, which maps virtual addresses used by a process 419 to physical addresses of the memory 409. The processor's memory management unit (MMU) can translate these virtual addresses to physical addresses, when used. The operating system 423 can use the virtual memory system to present more memory 409 to individual processes 419 than is physically available.

A number of software components discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), persistent memory, hard drive, solid-state drive, Universal Serial Bus (USB) flash drive, memory card, optical disc such as compact disc (CD) or digital versatile disc (DVD), floppy disk, magnetic tape, or other memory components.

Memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, graphics processing units (GPUs), field-programmable gate arrays (FPGAs), or other components, etc. Such technologies are generally well known by those skilled in the art and, consequently, are not described in detail herein.

Flowcharts can be used to describe the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although flowcharts can show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X, Y, or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. While concepts of the present disclosure are discussed with respect to a particular figure, the concepts can also be used in connection with the other figures. All such modifications and variations are intended to be included herein within the scope of this disclosure and protected by the following claims.

Therefore, the following is claimed:

1. A system, comprising:
at least one computing device comprising at least one processor; and
at least one memory comprising executable instructions, wherein the instructions are executed to cause the at least one computing device to at least:
identify at least one address specified in a blockchain request;
prescreen the blockchain request to determine a conflict status of the blockchain request, the conflict status being determined based at least in part on a comparison of the at least one address specified in a blockchain request to at least one address specified in a parallel execution batch;
place the blockchain request in the parallel execution batch or a subsequent parallel execution batch based at least in part on the conflict status of the blockchain request; and
perform the blockchain request as part of performing parallel processing of at least one of: the parallel execution batch, or the subsequent parallel execution batch.

2. The system of claim 1, wherein the blockchain request is placed in the parallel execution batch based at least in part on the conflict status being a negative conflict status that indicates that the at least one address specified in a blockchain request does not match the at least one address specified in the parallel execution batch.

3. The system of claim 1, wherein the blockchain request is placed in the subsequent parallel execution batch based at least in part on the conflict status being a positive conflict status that indicates that the at least one address specified in a blockchain request matches the at least one address specified in the parallel execution batch.

4. The system of claim 3, wherein the blockchain request is re-enqueued in an incoming queue prior to being placed in the subsequent parallel execution batch.

5. The system of claim 1, wherein the parallel execution batch is associated with a predetermined threshold number of blockchain requests that indicates the parallel execution batch is full.

6. The system of claim 1, wherein the at least one address identified from the blockchain request comprises a from address and a to address.

7. The system of claim 1, wherein the at least one address specified in the parallel execution batch comprises a plurality of from addresses and a plurality of to addresses corresponding to a corresponding plurality of blockchain requests in the parallel execution batch.

8. A non-transitory computer readable medium comprising machine-readable instructions that, when executed, cause at least one computing device to at least:
identify at least one address specified in a blockchain request;
prescreen the blockchain request to determine a conflict status of the blockchain request, the conflict status being determined based at least in part on a comparison of the at least one address specified in a blockchain request to at least one address specified in a parallel execution batch;
place the blockchain request in the parallel execution batch or a subsequent parallel execution batch based at least in part on the conflict status of the blockchain request; and
perform the blockchain request as part of performing parallel processing of at least one of: the parallel execution batch, or the subsequent parallel execution batch.

9. The non-transitory computer readable medium of claim 8, wherein the blockchain request is placed in the parallel execution batch based at least in part on the conflict status being a negative conflict status that indicates that the at least one address specified in a blockchain request does not match the at least one address specified in the parallel execution batch.

10. The non-transitory computer readable medium of claim 8, wherein the blockchain request is placed in the subsequent parallel execution batch based at least in part on the conflict status being a positive conflict status that indicates that the at least one address specified in a blockchain request matches the at least one address specified in the parallel execution batch.

11. The non-transitory computer readable medium of claim 10, wherein the blockchain request is re-enqueued in an incoming queue prior to being placed in the subsequent parallel execution batch.

12. The non-transitory computer readable medium of claim 8, wherein the parallel execution batch is associated with a predetermined threshold number of blockchain requests that indicates the parallel execution batch is full.

13. The non-transitory computer readable medium of claim 8, wherein the at least one address identified from the blockchain request comprises a from address and a to address.

14. The non-transitory computer readable medium of claim 8, wherein the at least one address specified in the parallel execution batch comprises a plurality of from addresses and a plurality of to addresses corresponding to a corresponding plurality of blockchain requests in the parallel execution batch.

15. A method comprising:
identifying at least one address specified in a blockchain request;
prescreening the blockchain request to determine a conflict status of the blockchain request, the conflict status being determined based at least in part on a comparison of the at least one address specified in a blockchain request to at least one address specified in a parallel execution batch;
placing the blockchain request in the parallel execution batch or a subsequent parallel execution batch based at least in part on the conflict status of the blockchain request; and
performing the blockchain request as part of performing parallel processing of at least one of: the parallel execution batch, or the subsequent parallel execution batch.

16. The method of claim 15, wherein the blockchain request is placed in the parallel execution batch based at least in part on the conflict status being a negative conflict status that indicates that the at least one address specified in a blockchain request does not match the at least one address specified in the parallel execution batch.

17. The method of claim 15, wherein the blockchain request is placed in the subsequent parallel execution batch based at least in part on the conflict status being a positive conflict status that indicates that the at least one address specified in a blockchain request matches the at least one address specified in the parallel execution batch.

18. The method of claim 17, wherein the blockchain request is re-enqueued in an incoming queue prior to being placed in the subsequent parallel execution batch.

19. The method of claim 15, wherein the parallel execution batch is associated with a predetermined threshold number of blockchain requests that indicates the parallel execution batch is full.

20. The method of claim 15, wherein the at least one address identified from the blockchain request comprises a from address and a to address.
